(19) United States
(12) Patent Application Publication
(10) Pub. No.: US 2013/0308754 A1
(43) Pub. Date: Nov. 21, 2013

(54) RADIATION GENERATING TARGET, RADIATION GENERATING TUBE, RADIATION GENERATING APPARATUS, AND RADIATION IMAGING SYSTEM

(71) Applicant: CANON KABUSHIKI KAISHA, Tokyo (JP)

(72) Inventors: Koji Yamazaki, Ayase-shi (JP); Miki Tamura, Kawasaki-shi (JP)

(73) Assignee: Canon Kabushiki Kaisha, Tokyo (JP)

(21) Appl. No.: 13/869,666

(22) Filed: Apr. 24, 2013

(30) Foreign Application Priority Data
May 15, 2012 (JP) 2012-111093

(51) Int. Cl. H01J 35/08; G01N 23/04

(52) U.S. Cl. CPC H01J 35/08; G01N 23/04
USPC 378/62; 378/143; 378/121; 378/101

(57) ABSTRACT

The present invention provides a transmission type radiation generating target which can suppress the exfoliation or the crack of a target layer in an interface between a supporting substrate and the target layer, even when the density of incident electrons has been enhanced or the potential of the target has been enhanced. The transmission type radiation generating target includes a supporting substrate, and a target layer which is arranged on the supporting substrate and generates radiation in response to irradiation with an electron beam, wherein the target layer has an opening through which the supporting substrate is exposed, and the opening overlaps with a position at which the density of the irradiation with the electron beam is maximum.

### BACKGROUND OF THE INVENTION

1. Field of the Invention

The present invention relates to a radiation generating target which can be applied to non-destructive X-ray imaging and the like in a medical equipment field and an industrial equipment field, and to a radiation generating tube, a radiation generating apparatus and a radiation imaging system, which are provided with the radiation generating target.

2. Description of the Related Art

Generally, a radiation generating apparatus accelerates electrons to be emitted from an electron source by high voltage, and makes the accelerated electrons irradiate a target formed from a metal such as tungsten to make the target generate radiation such as X-rays. The target which generates the radiation includes a reflecting type target from which a radiation having reflected on the surface of the target is taken out, and a transmitting type target from which a radiation having permeated through the target is taken out. When an electron beam which has been emitted from the electron source is incident on any one of the reflecting type target and the transmitting type target, most of the energy of the incident electron beam is converted into heat, and accordingly a temperature of the surface of the target becomes a high temperature.

In the transmitting type target, in particular, the radiation which has permeated through the target is used, and accordingly a target layer of a thin film is used so as to reduce the amount of absorption for the generated radiation. Because of this, when the target has been irradiated with the electron beam, the temperatures not only in the vicinity of the surface of the target but also in the vicinity of an interface between the target layer and a supporting substrate become high, a thermal stress is generated by a difference between coefficients of thermal expansion of the target layer and the supporting substrate, and there has been the case where the exfoliation of the target layer occurs in the interface between the target layer and the supporting substrate. When the exfoliation of the target layer has occurred, the thermal conductance at an exfoliating site decreases, and accordingly there is a possibility that the target layer melts, the dose of radiation decreases and the reliability remarkably decreases.

As a measure to this problem, in Japanese Patent Application Laid-Open No. 2002-298772, a concave surface is provided within the focus (region to be irradiated with electron beam) of a supporting substrate so as to oppose to an electron gun, thereby makes a target layer formed thereon pressed onto the supporting substrate when the target layer has thermally expanded, and suppresses the occurrence of the exfoliation and the crack.

On the other hand, in Japanese Patent Application Laid-Open No. 2002-343290, in order to prevent a target film from being sucked by a vacuum, such a structure is adopted that a notch or a pore from which the target film is removed is provided in the outside of a region to be irradiated with the electron beam of a transmitting type target, and accordingly that the target film is not strongly bonded to the substrate. As a result, the structure alleviates the difference between the coefficients of thermal expansion and suppresses the exfoliation of the target film due to the thermal expansion.

Incidentally, as radiographs have been widely taken, it has been demanded to further increase the dose of radiation and enhance the energy of the radiation. In order to increase the dose of the radiation, it is necessary to increase the density of the electrons incident on the target, and in order to enhance the energy of the radiation, it is necessary to enhance the potential of the target. When it is intended to increase the dose of the radiation or enhance the energy of the radiation, any method leads to the increase also of the thermal flux when electrons have been incident on the target. Accordingly, even if the technology described in Japanese Patent Application Laid-Open No. 2002-298772 has been applied to the target layer, the swelling exfoliation or the crack may have occurred in the vicinity of the boundary between the concave surface portion and a flat surface portion. When the exfoliation or the crack of the target has occurred, there is a possibility that the target melts while starting melting from the portion of the exfoliation or the crack, and the dose of the radiation may decrease.

On the other hand, in the technology described in Japanese Patent Application Laid-Open No. 2002-343290, the target film is not strongly bonded to the supporting substrate, and accordingly the thermal conductance decreases. For this reason, when it has been intended to increase the dose of the radiation and enhance the energy of the radiation, there has been a possibility that the exfoliation or the crack occurs.

Then, an object of the present invention is to provide a radiation generating target which can suppress the exfoliation or the crack of the target layer in the interface between the substrate and the target layer, even when the density of the incident electrons has been increased, or the potential of the target has been enhanced. In addition, an object of the present invention is also to provide a radiation generating tube, a radiation generating apparatus and a radiation imaging system, which are provided with the radiation generating target.

### SUMMARY OF THE INVENTION

In order to solve the above described problems, the present invention provides a radiation generating target which includes a supporting substrate, and a target layer that is arranged on the supporting substrate and generates radiation in response to irradiation with an electron beam, wherein the target layer has an opening which penetrates the target layer, and the opening overlaps with a position at which the density of the irradiation with the electron beam is maximum.

The present invention also provides a radiation generating target which includes a supporting substrate, and a target layer that is arranged on the supporting substrate and generates radiation in response to irradiation with an electron beam, wherein the target layer has an opening which penetrates the target layer, and the opening overlaps with a centroid of an irradiated region with the electron beam.

The present invention also provides a radiation generating target which includes a supporting substrate that has a portion to be bonded with an anode in a periphery thereof, and a target layer that is arranged on the supporting substrate and generates radiation in response to irradiation with an electron beam, wherein the target layer has an opening which penetrates the target layer, and the opening overlaps with a centroid of a region surrounded by the portion to be bonded.

Furthermore, the present invention provides a radiation generating tube, a radiation generating apparatus and a radiation imaging system, which are provided with the radiation generating target.

Further features of the present invention will become apparent from the following description of exemplary embodiments with reference to the attached drawings.

### BRIEF DESCRIPTION OF THE DRAWINGS

FIG. 1A and FIG. 1B are schematic views illustrating one example of a radiation generating target of the present invention, FIG. 1A is a top plan view, and FIG. 1B is a sectional view taken along the line 1B-1B of FIG. 1A.

FIG. 2 is a schematic sectional view illustrating another example of the radiation generating target of the present invention.

FIG. 3 is a block diagram of a radiation generating apparatus provided with the radiation generating target of the present invention.

FIG. 4A and FIG. 4B are schematic views illustrating one example of a method for forming a target layer.

FIG. 5A and FIG. 5B are schematic views illustrating another example of the method for forming the target layer, FIG. 5A is a top plan view, and FIG. 5B is a sectional view taken along the line 5B-5B of FIG. 5A.

FIG. 6 is a block diagram of a radiation imaging system of the present invention.

### DESCRIPTION OF THE EMBODIMENTS

Preferred embodiments of the present invention will now be described in detail in accordance with the accompanying drawings.

Embodiments of the present invention will be described below with reference to the drawings, but the present invention is not limited to the following embodiments. For information, a known or well-known art in the technical field shall be applied to a part which is not particularly illustrated or described in the present specification.

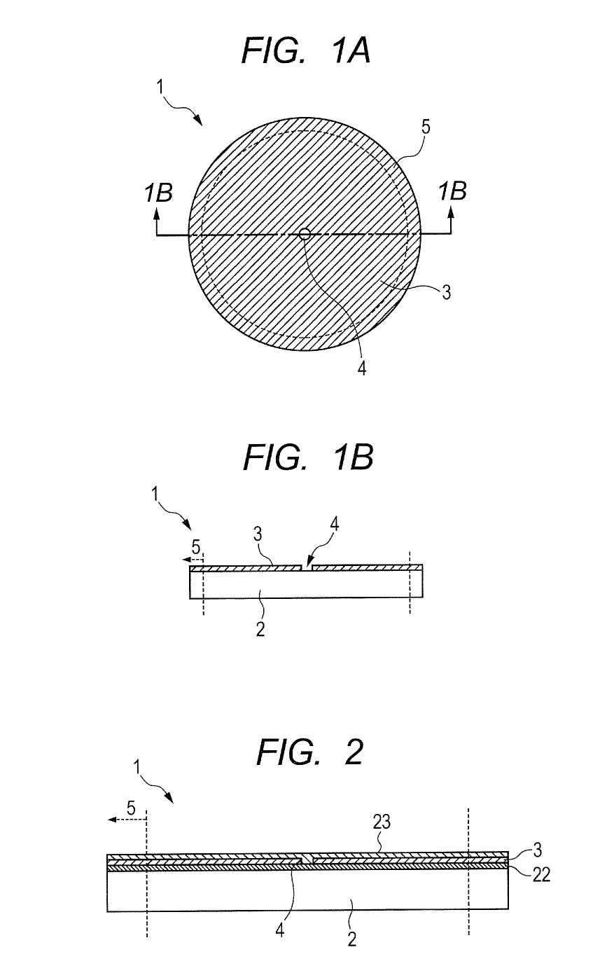

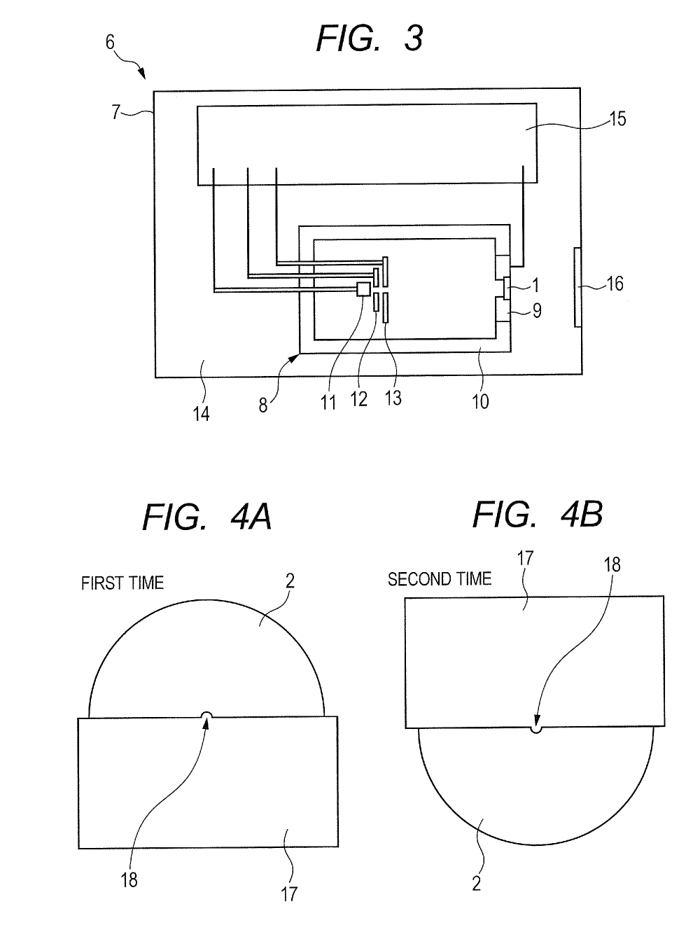

A radiation generating target (hereinafter referred to simply as “target”) 1 illustrated in FIG. 1A and FIG. 1B is a radiation transmission type target, and a target layer 3 which generates a radiation in response to irradiation with electrons is formed on a supporting substrate 2 that can transmit the radiation therethrough. The target layer 3 has an opening 4 in the irradiated region with the electron beam (not shown). The opening 4 penetrates the target layer 3 and, in the present example, the supporting substrate 2 is exposed through the opening 4. The target 1 has a portion to be bonded (region to be bonded) 5 for being bonded to an anode 9 (see FIG. 3) therethrough which will be described later, in its periphery.

The supporting substrate 2 has such a strength as to be capable of supporting the target layer 3 thereon, and can preferably be a supporting substrate having high thermal conductivity so as to little absorb the radiation generated in the target layer 3 and quickly radiate the heat generated in the target layer 3. Diamond, silicon carbide, silicon nitride or aluminum nitride, for instance, can be used as a material of the supporting substrate 2. The thickness of the supporting substrate 2 can preferably be 0.1 mm or more and 10 mm or less.

The target layer 3 generates the radiation in response to irradiation with an electron beam. A part of the generated radiation permeates the supporting substrate 2, and is emitted. The material which constitutes the target layer 3 can preferably be a material having a high melting point and a high efficiency of generating radiation. Tungsten, tantalum, molybdenum, or an alloy containing any of these metals, for instance, can be used as the material. The thickness of the target layer 3 can preferably be 2 μm or more and 20 μm or less, so as to reduce the amount of absorption occurring when the generated radiation permeates through the target layer 3.

The opening 4 can preferably be provided at the position of the target layer 3, at which the temperature becomes highest in response to the irradiation with the electron beam. When the opening 4 is provided at such a position, the radiation generating target reduces a thermal stress to be generated due to a difference between coefficients of thermal expansion of the target layer 3 and the supporting substrate 2, and can suppress the formation of a starting point of the exfoliation of the target layer 3. Because of this, the exfoliation of the film of the target layer 3 is suppressed, the melting of the target layer 3 can be prevented, and the decrease of the dose of the radiation can be suppressed even when the radiation generating apparatus has been driven for a long period of time.

The optimal position of the opening 4 to be provided in the target layer 3 varies depending on the distribution of the density of irradiation with an electron beam and on a position of a portion to be bonded 5. From the viewpoint of the thermal flux, for instance, when the distribution of the density of the irradiation with the electron beam is large, a temperature at such a position that the density of the irradiation is the highest tends to easily rise, and accordingly the position of the opening 4 can preferably be set in the vicinity of a place in which the density of the irradiation is the highest. Specifically, the opening 4 can preferably be arranged so as to overlap with the position at which the density of the irradiation with the electron beam is maximum. When the distribution of the density of the irradiation with the electron beam is small, the temperature at the barycentric position of the region to be irradiated with the electron beam tends to easily rise, and accordingly the position of the opening 4 can preferably be set in the vicinity of the centroid of the region to be irradiated with the electron beam. Specifically, the opening 4 can preferably be arranged so as to overlap with the centroid of the region to be irradiated with the electron beam. In addition, the heat which has been generated in the target layer 3 by the irradiation with the electron beam dissipates through radiation from the target 1 and thermal conduction to the portion to be bonded 5. From the viewpoint of heat transfer, a temperature of a region which is the farthest place from the portion to be bonded 5 that becomes a low-temperature side region, and in which thermal resistance from the low-temperature side region is the highest, in other words, a temperature of the barycentric position of a region which is surrounded by the portion to be bonded 5 tends to easily rise, and accordingly the opening 4 can preferably be arranged in the vicinity of the barycentric position. Specifically, the opening 4 can preferably be arranged so as to overlap with the centroid of the region which is surrounded by the portion to be bonded 5.

The centroid in the present invention means a centroid of an imagined plate material which has any of the shapes of a polygon, a circle and an ellipse and has the uniform thickness, when an outline in a target region shows any of the shapes. In addition, when the outline of the target region shows a shape other than the polygon, the circle or the ellipse, the centroid means a centroid of an imagined plate material that has any one shape selected from the polygon, the circle and the ellipse, which is close to the outline, and has the uniform thickness.

Usually, the center of the region surrounded by the portion to be bonded 5 approximately coincides with the center of the target layer 3, and approximately coincides also with the center of the region to be irradiated with the electron beam. Accordingly, the opening 4 can preferably be provided so as to overlap with the center of the target layer 3, also from the viewpoint of the thermal flux and the heat transfer.

As the opening 4 is large, the opening 4 increases the effect of alleviating the thermal stress, but on the other hand, the dose of the radiation decreases and an image quality deteriorates when used for the radiation imaging system. Because of this, the area of the opening 4 can preferably be 1% or more and 20% or less of the area of the region to be irradiated with the electron beam.

The shape of the opening 4 is not limited to the circle as illustrated in FIG. 1A and FIG. 1B, but may be a polygon, an ellipse and another shape closed by a curve.

A film-forming method such as a sputtering method, a vapor deposition method, an ion plating method and a CVD method can be used as a method for forming the target layer 3 on the supporting substrate 2.

A method of arranging a mask that shields a portion at which the opening 4 is formed on the supporting substrate 2 and film-forming the target layer 3 when the target layer 3 is film-formed can be used as a method for forming the opening 4. Such a method can be also used as to mask a portion other than the portion at which the opening 4 is formed with a photoresist, after the target layer 3 has been film-formed on the supporting substrate 2, and remove the target layer 3 in the portion at which the opening 4 is formed, by etching.

In the target 1 according to the present invention, an intermediate layer 22 for enhancing an adhesive strength between the supporting substrate 2 and the target layer 3 can be interposed between the supporting substrate 2 and the target layer 3, as is illustrated in FIG. 2. In addition, in order to suppress the lifting of the target layer 3, a protective layer 23 can be provided which covers the target layer 3 and the opening 4. By having this protective layer 23 provided thereon, the target can further enhance a force of suppressing the exfoliation of the film.

It is desirable that the intermediate layer 22 has adequate adhesiveness with each of materials which constitute the supporting substrate 2 and the target layer 3, and little absorbs the radiation which has been generated in the target layer 3. Specifically, materials for the intermediate layer 22 can include, for instance, titanium, chromium, vanadium, tantalum, and an alloy or a compound containing any of these metals. The thickness of the intermediate layer 22 can preferably be 0.01 μm or more and 0.1 μm or less. The protective layer 23 can preferably be a layer which has adequate adhesiveness with the materials that constitute the supporting substrate 2 or the target layer 3, and has a coefficient of thermal expansion close to those of the materials. In addition, the protective layer 23 is desirably formed from a material through which the electron intrudes into a deep portion and which has a comparatively small atomic number so that the protective layer 23 little absorbs the electron beam. Specifically, materials for the protective layer 23 can include, for instance, titanium, nickel, zirconium, chromium, niobium, silicon, and an alloy or a compound containing any of these metals. The protective layer 23 can preferably be continuously formed so as to cover the target layer 3 and the opening 4. The thickness of the protective layer 23 can preferably be 1 μm or more and 20 μm or less.

The above described embodiment can provide a target 1 which has the opening 4 provided in the target layer 3, thereby can suppress the film exfoliation of the target layer 3, little decreases the dose of the radiation even when having been driven for a long period of time, and has excellent reliability.

Next, a radiation generating tube and a radiation generating apparatus which use the radiation generating target of the present invention will be described below with reference to FIG. 3. A radiation generating apparatus 6 of the present invention has a radiation generating tube 8 provided in the inside of an envelope 7.

The radiation generating tube 8 includes a vacuum chamber 10, and an electron source 11 which is arranged in this vacuum chamber 10. The vacuum chamber 10 has an anode 9 to which the target 1 is fixed through the portion to be bonded 5 (see FIG. 1A, FIG. 1B and FIG. 2). In FIG. 3, a cathode (not-shown) provided with an electron source 11 and the anode 9 provided with the target 1 are arranged so as to separate the inside of the radiation generating tube 8 from the outside thereof. In the form illustrated in FIG. 3, it can be also said that the cathode and the anode 9 constitute parts of the vacuum chamber 10, respectively. The form illustrated in FIG. 3 can elongate a distance between the cathode and the anode 9 within a range of limitation of the size of the vacuum chamber 10, and accordingly is an appropriate form in a point that the radiation generating tube 8 can be driven with a high voltage. However, the arrangement of the target 1 in the present invention is not limited to the form illustrated in FIG. 3, but the target layer 3 (see FIGS. 1A and 1B) may be arranged in a position in which the target 1 can receive the irradiation with the electrons that have been emitted from the electron source 11. Accordingly, such a form that the target 1 provided with the target layer 3 is arranged in a state of being accommodated in the inside of the vacuum chamber 10 is also included in the aspect of the present invention. In addition, the electron source 11 can be provided so as to oppose to the target layer 3 of the target 1.

In the radiation generating tube 8, a drawing electrode 12 and a lens electrode 13 can be provided sequentially from the electron source 11 toward the target 1, as in the present embodiment. The drawing electrode 12 forms an electric field which draws electrons from the electron source 11. The lens electrode 13 converges the electrons which have been drawn by the electric field that has been formed by the drawing electrode 12. In other words, by having these electrodes provided therein, the radiation generating tube 8 can draw the electrons from the electron source 11 due to the electric field which is formed by the drawing electrode 12, can converge the drawn electrons with the lens electrode 13, and can make the converged electrons incident on the target layer 3 of the target 1. When the electrons are incident on the target layer 3, the radiation is thereby generated.

The vacuum chamber 10 has an insulating tube which is formed of an insulating material such as glass and a ceramic material, so as to keep the inside at a vacuum and also electrically insulate the electron source 11 from the anode 9. The above described cathode and the above described anode 9 which are positioned so as to be separated from each other are connected to this insulating tube, respectively, and the insulating tube is interposed between both of them. In addition, the inside of the vacuum chamber 10 is decompressed. The degree of vacuum may be approximately 10⁻⁴ Pa to 10⁻⁸ Pa. Specifically, when the degree of vacuum in the inside of the radiation generating tube 8 is 10⁻⁴ Pa to 10⁻⁸ Pa, the electron source 11 can be durable. The vacuum chamber 10 has a not-shown exhaust pipe provided therein, and the inside of the vacuum chamber 10 can be exhausted through this exhaust pipe. When the exhaust pipe is used, the inside of the vacuum chamber 10 can be kept in a decompressed state, if a part of the exhaust pipe has been sealed, after the inside of the vacuum chamber 10 has been exhausted through the exhaust pipe to become vacuum. In addition, a not-shown getter may be arranged in the inside of the vacuum chamber 10 so that the degree of vacuum can be kept.

The electron source 11 is arranged in the inside of the vacuum chamber 10 so as to oppose to the target layer 3. A hot cathode such as a tungsten filament and an impregnated type cathode and a cold cathode such as a carbon nanotube can be used as the electron source 11. When the drawing electrode 12 and the lens electrode 13 are arranged in the vicinity of the electron source 11, a voltage Va to be applied between the electron source 11 and the target 1 is approximately 40 kV to 150 kV, though the voltage Va varies depending on an application in which the radiation is used.

A surplus space in the inside of the envelope 7 which has accommodated the radiation generating tube 8 therein is filled with an insulating liquid 14. In addition, the envelope 7 accommodates a power source circuit 15 which is connected to the radiation generating tube 8 and controls the generation of the radiation by applying a voltage signal to the radiation generating tube 8, in its inside.

The envelope 7 is desirably an envelope which has a sufficient strength as a container and is excellent in heat radiation properties, and a metal material such as brass, iron and stainless steel can preferably be used as the material.

The insulating liquid 14 is a liquid which has electrical insulation properties, and for instance, an electric insulating oil which has roles of an insulating medium and a cooling medium of the radiation generating tube 8 can preferably be used as the insulating liquid. A mineral oil, a silicone oil and the like can preferably be used as the electric insulating oil. In addition, another usable insulating liquid 14 can include a fluorine-based electric insulating liquid.

The envelope 7 is provided with a radiation transmission window 16 for taking out the radiation therethrough which has been generated by the radiation generating tube 8, to the outside. The radiation which has been emitted from the radiation generating tube 8 is emitted to the outside through this radiation transmission window 16. Glass, aluminum, beryllium, polycarbonate and the like are used for the radiation transmission window 16.

Incidentally, a representative example of the radiation can include X-rays.

FIG. 6 is a block diagram of a radiation imaging system of the present invention.

A system controlling apparatus 102 controls a radiation generating apparatus 100 and a radiation detecting apparatus 101, in conjunction with both of them. A control section 105 outputs various control signals to the radiation generating tube 106 under the control of the system controlling apparatus 102. The emission state of the radiation which is emitted from the radiation generating apparatus 100 is controlled by the control signal. The radiation which has been emitted from the radiation generating apparatus 100 permeates an object 104, and is detected by a detector 108. The detector 108 converts the detected radiation into an image signal, and outputs the converted image signal to a signal processing section 107. The signal processing section 107 subjects the image signal to predetermined signal processing under the control of the system controlling apparatus 102, and outputs the processed image signal to the system controlling apparatus 102. The system controlling apparatus 102 outputs a display signal for displaying an image on a display apparatus 103 to the display apparatus 103, based on the processed image signal. The display apparatus 103 displays the image based on the display signal on a screen, as a captured image of the object 104.

### EXAMPLES

### Example 1

A radiation transmission type target 1 illustrated in FIG. 1A and FIG. 1B was produced. In FIG. 1A and FIG. 1B, a target 1, a supporting substrate 2, a target layer 3, an opening 4, and a portion to be bonded 5 for fixing the target 1 to an anode are shown.

The supporting substrate 2 was formed from diamond with a diameter of 5 mm and a thickness of 1 mm, and tungsten as the target layer 3 was film-formed on the supporting substrate 2 so as to become 10 μm thick with a sputtering process. The sputtering process was conducted twice separately while using a metal mask 17 illustrated in FIG. 4A and FIG. 4B, regarding the projecting portion 18 of the metal mask 17 as the center, and changing the position by 180 degrees around the projecting portion 18. Then, the opening 4 having no tungsten film-formed therein was formed in a region which overlapped with the projecting portion 18, and the target 1 was produced. The opening 4 was formed into a circle shape with a diameter of 0.2 mm, which was positioned in the center part of the supporting substrate 2.

The radiation generating apparatus illustrated in FIG. 3 was produced with the use of the above described produced target 1. In FIG. 3, a radiation generating apparatus 6 is shown, and has a radiation generating tube 8, a high-pressure power source circuit 15 and an insulating liquid 14 enclosed in an envelope 7 having the radiation transmission window 16. The radiation generating tube 8 includes the target 1, an anode 9, a vacuum chamber 10, an electron source 11, a drawing electrode 12 and a lens electrode 13.

Tungsten was used for the anode 9, and the target 1 was brazed to the anode 9 in the portion to be bonded 5. The vacuum chamber 10 was formed from alumina, and was exhausted through a not-shown exhaust pipe. In addition, an impregnated type cathode was used as the electron source 11.

In the radiation generating tube 8, potentials of the drawing electrode 12 and the lens electrode 13 are adjusted so that the electron beam which has been emitted from the electron source 11 forms a Gaussian distribution on the target 1, and the positions of the drawing electrode and the lens electrode 13 are adjusted so that the vertex of the Gaussian distribution overlaps with the center of the target layer 3 (position of formed opening 4).

The envelope 7 is formed from brass, and the radiation transmission window 16 is formed from glass. The radiation generating tube 8 and the power source circuit 15 were stored in the inside of the envelope 7, and an electric insulating oil was enclosed therein as an insulating liquid 14.

The radiation generating apparatus 6 produced in the above description was continuously driven at 100 kV while the temperature was monitored. The radiation generating apparatus 6 was driven until the temperature rise was saturated, and as a result, the dose of the radiation did not decrease. Furthermore, before and after the continuously driving, a pinhole was arranged in the proximity to the radiation transmission window 16, and the focal shapes of the radiation on the target 1 were photographed and compared. However, no defect was caused by the driving. In addition, the diameter of the focal size was approximately 2 mm. The focal size is approximately equal to a region to be irradiated with the electron beam, and the area of the opening 4 becomes 1% of the area of the region to be irradiated with the electron beam. The amount of generated radiation decreased by 4% compared to the case where there was no opening 4, but the level is such a level as to be capable of being covered by a driving system or the like.

### Example 2

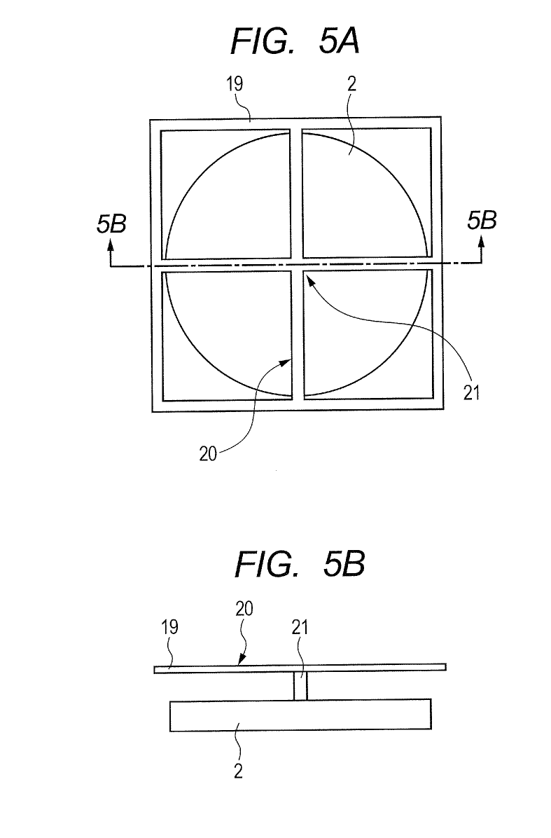

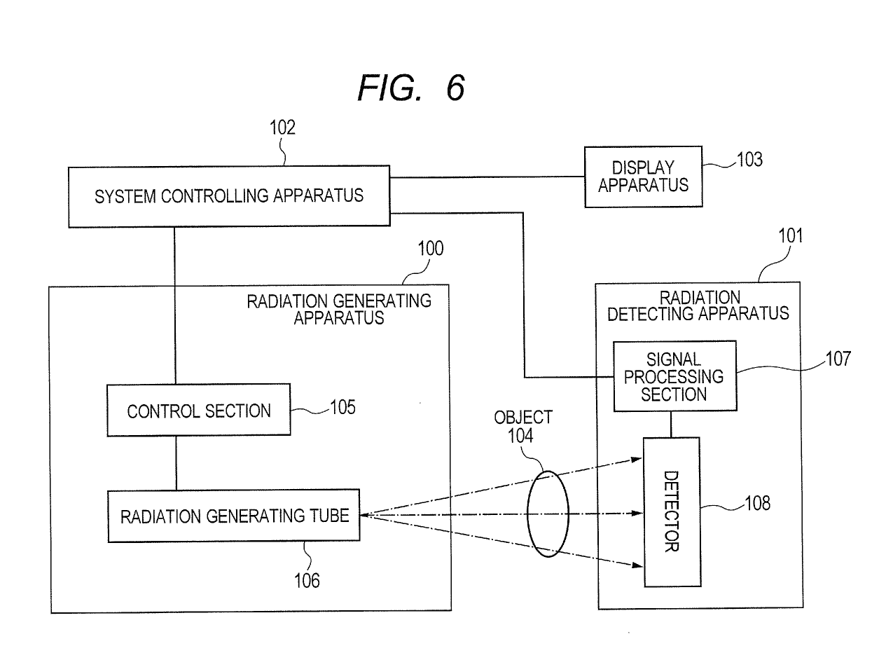

The radiation generating target of the present example is different from Example 1 in the form of the opening 4. A supporting substrate 2 was formed from diamond with a diameter of 5 mm and a thickness of 1 mm, and tungsten as the target layer 3 was film-formed on the supporting substrate 2 so as to become 10 μm thick with a sputtering process. The sputtering process was conducted with the use of a metal mask 19 illustrated in FIG. 5A and FIG. 5B, thereby the opening 4 was formed, and the target 1 was produced. The metal mask 19 has a cross arm portion 20 which has an intersection in a desired portion, and a rectangular columnar contact portion 21 for masking the supporting substrate 2, which projects in the intersection. This metal mask 19 is set in such a state that the contact portion faces to the supporting substrate 2 side and the tip of the contact portion is brought into contact with the supporting substrate 2. In a state in which the metal mask 19 is set, the region of the contact portion 21 is directly masked, but the arm portion 20 lifts from the supporting substrate 2. Accordingly, the target layer 3 is formed also on the part of the supporting substrate 2, which overlaps with the arm portion 20. As a result, the opening having a spot shape is formed. The pattern of the opening 4 was formed into a square with one side of 0.2 mm. The area of this opening 4 is 1.3% of the area of the region to be irradiated with electrons. The amount of generated radiation decreased by 6% compared to the case where there was no opening 4, but the level is such a level as to be capable of being covered by a driving system or the like.

The radiation generating apparatus was produced with the use of the target 1 which was produced in the above description, in a similar way to that in Example 1. This radiation generating apparatus 6 was continuously driven at 100 kV while the temperature was monitored. The radiation generating apparatus 6 was driven until a temperature rise was saturated, but the dose of the radiation did not decrease. Furthermore, before and after the continuous driving, the focal shape was photographed and compared with the use of a pinhole similar to that in Example 1, but no defect was caused by the driving.

The radiation generating target according to the present invention can reduce a thermal stress to be generated by a difference between coefficients of thermal expansion of the target layer and the supporting substrate, and can suppress the exfoliation of the target layer in the interface between the supporting substrate and the target layer. Thereby, the radiation generating target can prevent the target layer from melting due to the decrease of the thermal conductance at an exfoliating site.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-111093, filed May 15, 2012, which is hereby incorporated by reference herein in its entirety.

What is claimed is:

1. A radiation generating target comprising a supporting substrate, and a target layer which is arranged on the supporting substrate and generates radiation in response to irradiation with an electron beam, wherein
the target layer has an opening which penetrates the target layer, and
the opening overlaps with a position at which the density of the irradiation with the electron beam is maximal.

2. A radiation generating target comprising a supporting substrate, and a target layer which is arranged on the supporting substrate and generates radiation in response to irradiation with an electron beam, wherein
the target layer has an opening which penetrates the target layer, and
the opening overlaps with a centroid of an irradiated region with the electron beam.

3. A radiation generating target comprising a supporting substrate which has a portion to be bonded with an anode in a periphery thereof, and a target layer which is arranged on the supporting substrate and generates radiation in response to irradiation with an electron beam, wherein
the target layer has an opening which penetrates the target layer, and
the opening overlaps with a centroid of a region surrounded by the portion to be bonded.

4. The radiation generating target according to claim 1, wherein an area of the opening is 1% or more and 20% or less of an area of an irradiated region with the electron beam.

5. The radiation generating target according to claim 1, further comprising an intermediate layer for enhancing adhesion between the supporting substrate and the target layer, which is interposed between the supporting substrate and the target layer.

6. The radiation generating target according to claim 5, wherein the intermediate layer is formed from titanium, chromium, vanadium, tantalum, or an alloy or compound containing any of these metals.

7. The radiation generating target according to claim 6, wherein the intermediate layer has a thickness of 0.01 μm or more and 0.1 μm or less.

8. The radiation generating target according to claim 1, further comprising a protective layer for suppressing lifting of the target layer, which is provided so as to cover the target layer and the opening.

9. The radiation generating target according to claim 8, wherein the protective layer is formed from titanium, nickel, zirconium, chromium, niobium, silicon, or an alloy or compound containing any of these metals.

10. The radiation generating target according to claim 9, wherein the protective layer has a thickness of 1 μm or more and 20 μm or less.

11. The radiation generating target according to claim 1, wherein the supporting substrate is formed from a substance selected from the group consisting of diamond, silicon carbide, silicon nitride and aluminum nitride.

12. The radiation generating target according to claim 11, wherein the supporting substrate has a thickness of 0.1 mm or more and 10 mm or less.

13. The radiation generating target according to claim 1, wherein the target layer is formed from tungsten, tantalum, molybdenum, or an alloy containing any of these metals.

14. The radiation generating target according to claim 13, wherein the target layer has a thickness of 2 μm or more and 20 μm or less.

15. A radiation generating tube comprising:
the radiation generating target according to claim 1;
an anode to which the radiation generating target is connected;
an electron source which is opposite to the target layer that is provided in the radiation generating target;
a cathode connected to the electron source; and
an insulating tube to which the cathode and the anode that are arranged so as to be separated from each other are connected, and which is interposed between the cathode and the anode.

16. The radiation generating tube according to claim 15, wherein the radiation generating target and the anode separate an inside of the radiation generating tube from an outside thereof.

17. A radiation generating apparatus comprising:
the radiation generating tube according to claim 15;
a power supply circuit which is electrically connected to the radiation generating tube and controls the generation of radiation by applying a voltage signal to the radiation generating tube; and
an envelope that accommodates the radiation generating tube and the power supply circuit therein and has a radiation transmission window through which radiation generated in the radiation generating tube is taken out to the outside.

18. A radiation imaging system comprising:
the radiation generating apparatus according to claim 17;
a radiation detecting apparatus which detects radiation that has been emitted from the radiation generating apparatus and has permeated an object; and
a controlling apparatus which jointly controls the radiation generating apparatus and the radiation detecting apparatus.

19. A radiation generating tube comprising:
the radiation generating target according to claim 2;
an anode to which the radiation generating target is connected;
an electron source which is opposite to the target layer that is provided in the radiation generating target;
a cathode connected to the electron source; and
an insulating tube to which the cathode and the anode that are arranged so as to be separated from each other are connected, and which is interposed between the cathode and the anode.

20. A radiation generating tube comprising:
the radiation generating target according to claim 3;
an anode to which the radiation generating target is connected;
an electron source which is opposite to the target layer that is provided in the radiation generating target;
a cathode connected to the electron source; and
an insulating tube to which the cathode and the anode that are arranged so as to be separated from each other are connected, and which is interposed between the cathode and the anode.
